(19) United States
(12) Patent Application Publication
(10) Pub. No.: US 2026/0083606 A1
(43) Pub. Date: Mar. 26, 2026

(54) WHEELCHAIR WHEEL SYSTEM

(71) Applicant: EPPUR, LOOS (FR)

(72) Inventors: Colin GALLOIS, LILLE (FR); Lancelot DURAND, LILLE (FR); Matthias PORTELLANO, SAINT MALO (FR)

(21) Appl. No.: 19/110,893

(22) PCT Filed: Sep. 6, 2023
(86) PCT No.: PCT/EP2023/074393

§ 371 Date: Mar. 12, 2025

(30) Foreign Application Priority Data
Sep. 13, 2022 (FR) FR2209202

(51) Int. Cl. A61G 5/10; A61G 5/02; F16D 41/06

(52) U.S. Cl. CPC A61G 5/1027; A61G 5/022; F16D 41/06

(57) ABSTRACT

Wheel system comprising a wheel having a hub with a main axis (X), the hub comprising an inner face with an inner conical surface; a tubular element; a main shaft inserted into the tubular element; a hand-rim comprising an extension portion having a threaded portion; a braking pad having a braking surface and a first conical surface; a coupling member translatably movable axially between a first position in which it rotatably links the hand-rim and the hub, and a second position for braking the hub; a freewheel arranged between the tubular element and the hub; and a blocking part for blocking the rotation of the tubular element relative to the frame.

### CROSS REFERENCE TO RELATED APPLICATIONS

This application is the U.S. National Stage, under 35 U.S.C. § 371, of International Application No. PCT/EP2023/074393, filed Sep. 6, 2023, which claims the benefit of FR2209202 filed Sep. 13, 2022, the contents of each of which are hereby incorporated by reference herein.

### TECHNICAL FIELD

The present application relates to the technical field of wheelchairs and more precisely to the field of wheel systems for such wheelchairs. Wheel systems traditionally comprise a wheel having a hub and a mechanism for driving this wheel relative to the frame of the wheelchair.

The present application relates in particular to wheel systems comprising a hand-rim coupled to the wheel and allowing the wheel to be driven in rotation forward and in reverse but also to accomplish the braking of the wheel.

### PRIOR ART

Known is a wheelchair provided with a wheel system like that described in document W02019193277. The wheel system of this document comprises a first shaft portion on which is mounted an extension portion of the hand-rim cooperating with a coupling member movable in axial translation. The coupling member allows coupling the wheel and the hand-rim in rotation when it is placed in a first position, for driving the wheel forward. The coupling member can also assume a second position in which it pushes a brake shoe radially against the hub, allowing braking of the wheel but also driving the wheel in reverse.

One disadvantage of this wheel system is that it comprises two shaft portions movable in rotation relative to one another. The first shaft portion is configured to be pivotally mounted to the frame of the chair by means of a freewheel clutch having an inner ring integral with a second shaft portion attached to the frame. The degree of freedom existing between the first and second shaft portion risks generating a large clearance, particularly in the angular travel of the coupling member, but also in the axial movement of the coupling member, which is not desirable. Taking into account this residual clearance, the user may be required to pivot the hand-rim through this lost motion through a relatively great angular travel before the latter drives the wheel forward where the braking of the wheel occurs. This lost angular travel of the hand-rim reduces the controllability of the wheel system and gives the user a feeling of insecurity, in that the braking of the chair is not immediate.

In addition, the extension portion of the hand-rim of this wheel system is mounted directly on the first shaft portion by means of a rolling-element bearing. Likewise, the inner ring of the freewheel clutch is directly attached to the second shaft portion. In addition, the second shaft portion is blocked in rotation relative to the frame by means of a blocking part mounted directly on the second shaft portion. In other words, a distinct mounting solution is selected for the respective mounting of the extension portion of the hand-rim, of the inner ring of the freewheel clutch and of the blocking part onto the main shaft portions.

The mounting of these different elements directly onto the first and second shaft portion can prove difficult and necessitate adapting these shaft portions for the purpose of mounting, by providing on them recesses, notches, flats in particular and/or by associating with them mounting means specific to each of these elements.

In addition, the wheel system according to the prior art makes access to the shaft portions difficult. In particular, it is necessary to disassemble substantially the entire wheel system to proceed with the replacement of these shaft portions.

### Disclosure

One object of the present application is to propose a wheel system correcting the aforementioned disadvantages.

To this end, the application applies to a wheelchair wheel system having a frame, the wheel system comprising:
a wheel having a hub having a main axis, the hub comprising an inner face provided with an inner conical surface;
a main shaft configured to be mounted on the frame of the wheelchair;
a tubular element extending along the main axis, the main shaft being engaged in said tubular element;
a hand-rim mounted pivotally around the main axis relative to the tubular element and coupled to the wheel for driving in rotation and braking of the wheel, the hand-rim comprising a circular actuation portion and an extension portion extending in the hub, said extension portion surrounding the tubular element and having a threaded portion;
at least one brake shoe located in the hub and comprising a braking surface and at least one first conical surface;
a coupling member comprising a coupling surface, a ramp and a threaded portion engaged with the threaded portion of the extension portion of the hand-rim to move the coupling member axially relative to the hub, the coupling member being movable in axial translation between at least one first position in which its coupling surface is supported against the inner conical surface of the hub, so as to link the hand-rim and the hub in rotation, and a second position in which the ramp of the coupling member presses against the first conical surface of the brake shoe to radially push the brake shoe against the inner face of the hub;
an freewheel clutch comprising an inner ring fixed relative to the tubular element and an outer ring blocked in rotation relative to the inner ring in a first rotation direction and free in rotation relative to the inner ring in a second rotation direction opposite to the first rotation direction, the hub of the wheel being mounted pivotally relative to the outer ring of the freewheel clutch, the brake shoe being linked in rotation with the outer ring of the freewheel clutch when the coupling member is in the second position; and
a blocking part integral with the tubular element and located opposite the hand-rim, the blocking part being configured to cooperate with a blocking element of the frame.

The wheel advantageously comprises a rim connected to the hub, for example by means of spokes. The wheel advantageously comprises a tire mounted on said rim.

The main shaft preferably extends along the main axis. The main shaft extends at least partially inside the tubular element. The main shaft is preferably of cylindrical shape. The tubular element advantageously has the shape of a sleeve. The tubular element is hollow. Preferably, the main shaft passes through said tubular element. The main shaft is preferably formed from a single identical part. The tubular element and the main shaft are preferably coaxial.

The tubular element advantageously has a length that is less than the length of the main shaft, preferably a length less than two-thirds of the length of the mains shaft. The tubular element advantageously has a length substantially equal to the length of the hub considered along the main axis. The tubular element preferably extends essentially inside the hub.

Without departing from the scope of the application, the tubular element can be blocked in rotation relative to the main shaft.

Preferably, the tubular element is blocked in axial translation relative to the main shaft.

Preferably, the tubular element is blocked in axial translation relative to the main shaft when the main shaft is mounted on the frame of the wheelchair.

The main shaft preferably comprises a nut, attached to the end of the main shaft, on which the tubular element is abutted for blocking the tubular element in axial translation relative to the main shaft in one axial movement direction.

Preferably, the tubular element or the blocking part is configured to abut against a portion of the frame for blocking the tubular element in axial translation relative to the main shaft in another axial movement direction.

The main shaft is preferably configured to be removably mounted to the frame of the wheelchair.

Preferably, the wheel system comprises at least one ring arranged between the main shaft and the tubular element. This ring is preferably fitted to the main shaft and is supported on a shoulder formed inside the tubular element. This ring allows the mounting of the main shaft inside the tubular element. The size of the ring is selected depending on the diameter of the main shaft.

The main shaft is advantageously configured to extend inside a mounting portion, for example a spindle barrel, of the frame of the wheelchair, when it is mounted to said frame. Preferably, the main shaft is configured to be blocked in axial translation relative to the frame of the wheelchair when it is mounted on the latter. When it is mounted to the frame of the wheelchair, said main shaft can be free in rotation around the main axis relative to said frame.

The tubular element of the wheel system according to the application constitutes an intermediate mounting part for the mounting in particular of the inner ring of the freewheel clutch, of the extension portion of the hand-rim and of the blocking part. The inner ring of the freewheel clutch, the extension portion of the hand-rim and of the blocking part are not mounted directly on the main shaft. It is therefore not necessary to modify the main shaft and to adapt it for the mounting of these elements. The mounting of the freewheel clutch, of the hand rail and of the blocking part is thereby facilitated. The application also allows using a standard main shaft, commercially available and suitable for all types of wheelchairs.

The wheel system according to the application can consequently be mounted and assembled to numerous chairs, without substantial modification to the wheel system, in that within the wheel system only the main shaft must be selected and adapted depending on the frame of the wheelchair. A connector can also be associated with the frame of the wheelchair, integral with the blocking element, for example for blocking the tubular element in rotation relative to the frame. This connector is preferably attached to the frame.

The tubular element of the wheel system according to the application allows liberating the main shaft relative to the hub by disengaging it from said tubular element. It is not necessary to disassemble the other parts and elements composing the wheel system for changing and replacing the main shaft.

Moreover, the wheel system according to the application allows the use of a single main shaft blocked in translation relative to the frame, unlike wheel systems according to the prior art which provide for the use of two distinct shaft portions. In particular, due to the application, the inner ring of the freewheel clutch is fixed relative to the frame of the wheelchair. One benefit is to reduce the clearance within the wheel system by reducing the number of parts and therefore the number of degrees of freedom between the parts composing the wheel system.

The hub is preferably mounted pivotally relative to the outer ring of the freewheel clutch around the main axis. The wheel system preferably comprises an external bearing, for example a ball bearing, arranged between the outer ring of the freewheel clutch and the inner face of the hub. Advantageously, the freewheel clutch is a cam-type freewheel clutch.

The freewheel clutch is preferably located between the extension portion of the hand-rim and the blocking part.

Preferably, the wheel system comprises two brake shoes. The brake shoes preferably extend on either side of the tubular element.

In the first rotation direction, the outer ring of the freewheel clutch is blocked in rotation relative to the inner ring, while in the second rotation direction, the outer ring is free in rotation relative to the inner ring. Thus, when the brake shoe is coupled in rotation with the outer ring of the freewheel clutch, it is consequently blocked in rotation relative to the inner ring of the freewheel clutch, and therefore relative to the tubular element, in the first rotation direction, and free in rotation relative to the inner ring, and therefore to the tubular element, in the second rotation direction.

Preferably, the brake shoe is coupled in rotation with the outer ring of the freewheel clutch around the main axis, regardless of the position of the coupling member.

According to a first non-limiting alternative, the brake shoe can cooperate directly with the outer ring of the freewheel clutch. According to another non-limiting alternative, the brake shoe can cooperate with a plug integral with the outer ring of the freewheel clutch.

Preferably, the circular actuation portion of the hand-rim extends radially relative to the tubular element and to the main shaft. The user advantageously pivots the hand-rim by driving in rotation said circular actuation portion. The circular actuation portion of the hand-rim is advantageously provided with knobs.

Preferably, the circular actuation portion is integral with the extension portion of the hand-rim. Preferably, the circular actuation portion and the extension portion of the hand-rim are two distinct part secured together, for example by means of screws. The circular actuation portion and the extension portion of the hand-rim can be single identical part.

The coupling member is advantageously in helical connection with the extension portion of the hand-rim. The threaded portion of the coupling member is advantageously a tapped portion, the tapping of which is configured to cooperate with the threading of the threaded portion of the extension portion. The coupling surface of the coupling member is advantageously a conical surface. It is advantageously inclined relative to the main axis, considered in a longitudinal section plane.

Preferably, the brake shoe has the shape of a portion of a cylinder. The brake shoe is advantageously arranged between the hub, the coupling member and a plug. Advantageously, the wheel system comprises two shoes arranged on either side of the tubular element, and diametrically opposed.

Preferably, the blocking part is attached to one end of the tubular element. The blocking part and the circular actuation portion of the hand-rim preferably extend on either side of the hub.

Without departing from the scope of the application, the blocking part and the tubular element can form only a single identical part.

Preferably, the blocking part is configured to cooperate with the blocking element of the frame to block the tubular element in rotation relative to the frame.

The blocking part advantageously cooperates with the blocking element of the frame for blocking the tubular element in rotation relative to the frame in one rotation direction.

In a non-limiting manner, and without departing from the scope of the application, the blocking part can cooperate with the blocking element of the frame for blocking the tubular element in rotation relative to the frame in the two rotation directions.

In a non-limiting manner, the blocking element can be a portion of the frame of the wheelchair, for example a tubular framework portion extending radially relative to the main axis of the wheel when the latter is mounted on the frame.

The pivoting of the hand-rim in a first rotation direction, corresponding to a rotation direction of the wheel for forward movement of the wheelchair, causes the movement in axial translation of the coupling member in a first displacement direction, toward the conical surface of the inner face of the hub, until said coupling member is brought into coupling in the first position.

In this first position, the coupling surface of the coupling member comes into abutment against the conical surface of the inner face of the hub, so that the axial movement of the coupling member is interrupted. From then on, the hand-rim and the hub are coupled in rotation around the main axis, in the first rotation direction. In the first position, the hand-rim drives the hub in the first rotation direction. The pivoting of the hand-rim in the first rotation direction drives the movement of the wheel in this same first rotation direction, corresponding to a forward movement of the chair. In this first rotation direction of the hub, the outer ring of the freewheel clutch is blocked in rotation relative to the inner ring. The hub being mounted pivotally relative to the outer ring of the freewheel clutch, the wheel can however pivot relative to the freewheel clutch and therefore to the tubular element around the main axis.

From this first position, when the user stops pivoting the hand-rim, the coupling member moves axially slightly in a second movement direction, opposite to the first movement direction. This second movement direction corresponds to a movement opposite to the conical surface of the inner face of the hub, directed toward the brake shoe. Taking into account this slight axial movement, the coupling surface of the coupling member is no longer supported against the conical surface of the inner face of the hub and the coupling between the hand-rim and the wheel is interrupted. The wheel, however, continues its pivoting in the first rotation direction, allowing the chair to advance.

Preferably, when the coupling member is in the first position, the distance between the ramp of the coupling member and the first conical surface of the brake shoe is less than 2 millimeters, preferably less than one millimeter.

In order to accomplish the braking of the wheel, the user pivots the hand-rim in a second rotation direction opposite to the first rotation direction. This second rotation direction corresponds to a braking direction or even to a reverse movement direction for the chair.

The coupling member is driven in axial translation by the extension portion of the hand-rim and moves axially in the second movement direction, toward the brake shoe. Preferably, in the second movement direction, the coupling member is moved toward the freewheel clutch.

The coupling member is moved until it attains the second position, in which its ramp presses against the first conical surface of the brake shoe. The coupling member then pushes the brake shoe, which is moved radially toward the inner surface of the hub. The braking surface of the brake shoe is then supported against the inner surface of the hub, thus accomplishing the braking of the wheel.

In other words, the pivoting of the hand-rim in the second rotation direction drives the braking of the wheel, slowing its pivoting relative to the frame of the wheelchair.

During braking, during the slowing phase and until its complete stop, the wheel continues to turn in the first rotation direction corresponding to a forward movement of the chair. In this first rotation direction, and therefore during braking, the outer ring of the freewheel clutch is blocked in rotation relative to the inner ring of the freewheel clutch. The wheel can however pivot, taking into account the pivot linkage between the hub and the outer ring of the freewheel clutch.

Preferably, the wheel system comprises a plug integral with the outer ring of the freewheel clutch, the brake shoe being movable in translation relative to said plug. The brake shoe is advantageously blocked in rotation relative to the plug. Preferably, the plug comprises a housing in which the freewheel clutch is arranged. It is understood that the plug allows coupling the brake shoe in rotation relative to the outer ring of the freewheel clutch.

Preferably, the brake shoe also comprises a second conical surface, inclined relative to the first conical surface. The plug advantageously has a conical plug surface, the second conical surface of the brake shoe being configured to be supported against said conical plug surface when the coupling member is in the second position. It is understood that when the coupling member is in the second position, the brake shoe is sandwiched between the plug and the coupling member.

When the wheel pivots in the first rotation direction and therefore in particular during braking, the plug and the brake shoe are blocked in rotation relative to the tubular element, taking into account the blockage in rotation of the outer ring of the freewheel clutch.

To pivot the wheel in the second direction of rotation, corresponding to a reverse movement of the chair, the user also pivots the hand-rim in this second direction of rotation. Consequently, the coupling member is brought into the second position in which the brake shoe pushes so as to move it radially. The braking surface of the brake shoe is pressed against the inner face of the hub, thus generating a coupling between the hand-rim and the hub in this second rotation direction, by means of the brake shoe and of the coupling member. In this second rotation direction of the hub, the outer ring of the freewheel clutch is free in rotation relative to the inner ring. The pivoting of the hub in the second rotation direction is allowed by the coupling in rotation of the brake shoe with the outer ring of the freewheel clutch, which is itself free in rotation relative to the inner ring of the freewheel clutch in this second direction of rotation.

In this second position of the coupling member, the plug is also coupled to the brake shoe and to the hub. The plug and the brake shoe also pivot in this second rotation direction.

A movement of the hand-rim in a second direction of rotation causes the movement in rotation of the wheel in this second rotation direction, corresponding to a reverse movement of the chair.

Preferably, between the first position and the second position, the coupling member moves axially by a distance less than 2 millimeters, more preferably less than one millimeter.

Preferably, when the coupling member is in the second position, the distance between the coupling surface of the coupling member and the inner conical surface of the inner face of the hub is less than 2 millimeters, preferably less than one millimeter. Preferably, the wheel system is formed so that the distance between the coupling surface of the coupling member and the inner conical surface of the inner face of the hub, when the coupling member is in the second position, is the shortest possible without however generating contact between these two surfaces.

Preferably, the main shaft is provided with an adjusting nut configured to be supported on one end of the tubular element. This adjusting nut allows adjusting the axial position of the plug and therefore adjusting the distance between the plug and the coupling member. This allows adjusting the distance between the ramp of the coupling member and the first conical surface of the brake shoe, but also the distance between the coupling surface of the coupling member and the inner conical surface of the inner face of the hub.

Preferably, the wheel system comprises at least one first bearing located inside the hub and arranged between said threaded portion of the extension portion of the hand-rim and said tubular element. It is understood that the first bearing is located in an interior volume defined by the hub. One benefit is to improve the radial and lateral retention of the extension portion of the hand-rim, particularly at the threaded portion of the extension portion of the hand-rim, which is subjected to large forces taking into account the cooperation between said extension portion and the coupling member and in particular the lever arm formed by the extension portion of the hand-rim, which is subjected to large forces in all directions. The first bearing allows avoiding swiveling between the hand-rim and the wheel. The first bearing preferably comprises a ball bearing. The first bearing allows accomplishing long centering of the extension portion of the hand-rim.

Advantageously, the extension portion of the hand-rim comprises a cylindrical portion located between the threaded portion and the circular actuation portion, the wheel system also comprising a second bearing arranged between said cylindrical portion of the extension portion and said tubular element. One benefit is to further improve the radial and lateral retention of the extension portion and to limit even more effectively the swiveling between the hand-rim and the wheel. Another advantage is to ensure coaxiality between the extension portion and the tubular element, in addition to ensuring guiding in rotation of said extension portion.

The second bearing advantageously comprises a ball bearing.

Preferably, the wheel system also comprises an external bearing arranged between the outer ring of the freewheel clutch and the hub. One benefit is to guide the pivoting of the hub relative to the tubular element and to improve the radial and axial retention of the hub in order to hold constant the inclination of the wheel and in order to avoid swiveling between the hand-rim and the wheel.

Alternatively, and without departing from the scope of the application, the wheel system can comprise an external bearing arranged between a plug integral with the outer ring of the freewheel clutch and the hub.

The external bearing preferably comprises a ball bearing.

Preferably, the wheel system also comprises an external bearing arranged between the extension portion of the hand-rim and the hub.

Advantageously, the blocking part has the general shape of a disk, a plurality of openings being provided in the disk and arranged on the periphery of a circle centered on the center of the disk. One benefit is to facilitate the initiation of cooperation between the blocking element and the blocking part, while reducing the weight of said blocking part.

The blocking element preferably comprises a blocking pin for cooperating with any one of the openings in the blocking part.

Said openings of the blocking part are preferably of oblong shape, in order to further facilitate the initiation of cooperation between the blocking element and the blocking part. In particular, during the initiation of cooperation, this oblong shape allows a large tolerance margin as to the radial position of the blocking element relative to the main axis, without however significantly increasing the clearance between the blocking element and the blocking part once assembled.

Preferably, said blocking part has a lateral face configured to come into abutment on a portion of the frame when the main shaft is mounted on said frame. One benefit is to block the axial translation of the wheel system relative to the frame of the wheelchair, directed toward the frame. In other words, the lateral face of the blocking part limits the movement of the wheel system during mounting of the main shaft on the frame.

The blocking part preferably comes into abutment on a spindle barrel of the frame of the wheelchair.

Preferably, the main shaft also comprises at least one abutment element configured to come into abutment against a portion of the frame of the wheelchair. The abutment element allows blocking the axial displacement of the main shaft in a direction opposite to said frame. The abutment element preferably comprises at least one ball. The abutment element preferably blocks the axial movement of the wheel system in a first mounting direction while the lateral face of the blocking part preferably blocks the axial movement of the wheel system in a second mounting direction, opposite to the first mounting direction.

Advantageously, the distance between the lateral face of the blocking part and the abutment element is substantially equal to the width of the mounting portion of the frame, for example of the spindle barrel, within which the main shaft extends. Preferably, the mounting portion of the frame is sandwiched between the lateral face of the blocking part and the abutment element of the main shaft.

According to a particularly advantageous aspect, the wheel system also comprises a friction part arranged between the hand-rim and the wheel and configured to generate a friction torque between said hand-rim and the wheel during the pivoting of said wheel. One benefit is to drive the hand-rim in rotation around the main axis during pivoting of the wheel, and of the hub around this same main axis. Henceforth, the hand-rim follows the rotation movement of the wheel. This allows in particular avoiding that the hand-rim remains immobile when the wheel is driven in rotation.

Consequently, when the wheel pivots in the first rotation direction, corresponding to a forward movement of the wheelchair, the hand-rim is also driven in rotation in this first rotation direction. The coupling surface of the coupling member tends to come into abutment against the inner conical surface of the inner face of the hub. Likewise, the hand-rim does not remain immobile during pivoting of the wheel. One benefit is to reduce the amplitude of the thrust that the user must exert on the hand-rim in order to bring the coupling member into the first position for the coupling of the hub and of the hand-rim.

Likewise, when the wheel pivots in the second rotation direction, corresponding to a reverse movement of the wheelchair, the hand-rim is also driven in rotation in this second rotation direction. The ramp of the coupling member tends to come into abutment against the first conical surface of the brake shoe. One benefit is to reduce the amplitude of the thrust that the user must exert on the hand-rim in order to bring the coupling member into the second position for the coupling of the hub and of the hand-rim via the brake shoe.

In other words, the friction part allows reducing the amplitude of the thrust to be exerted on the hand-rim leading to the coupling of the hand-rim and of the hub and therefore to driving in rotation of the wheel. Thrust on the hand-rim is translated into almost immediate driving in rotation of the wheel. The maneuverability of the chair as well as the safety of the user are improved.

Advantageously, the friction part is arranged between the extension portion of the hand-rim and the hub. The friction part is preferably arranged inside the hub. The friction part can be attached to the hub or to the hand-rim.

Preferably, said friction part comprises a seal, for example a lip seal, also called an SPI seal. Said seal advantageously comprises a flexible lip for generating a friction torque between the hand-rim and the hub.

Preferably, the wheel system also comprises an axial guide element mounted pivotally around the tubular element, the coupling member being movable in translation along the main axis relative to said axial guide element while being blocked in rotation around the main axis relative to this axial guide element, the axial guide element comprising a friction portion cooperating with the tubular element and configured to exert a friction torque on said tubular element.

The friction torque exerted by the axial guide element tends to oppose the pivoting of said axial guide element, and therefore of the coupling member, around the main axis. The axial guide element is advantageously configured to prevent the pivoting of the coupling member when the latter is brought from the first position into the second position and conversely. The axial guide element is advantageously configured to allow the pivoting of the coupling member around the main axis when the latter is in the first position or in the second position.

One benefit is to reduce the clearance that can appear when the coupling member passes from the first to the second position and conversely, by eliminating a degree of freedom, namely the degree of rotation of the coupling member around the main axis. In other words, one benefit is to prevent the rotation of the coupling member when it moves axially between the first and the second position, thus limiting the lost angular travel of the hand-rim.

Preferably, said friction portion is deformable and is configured to prevent the pivoting of the coupling member relative to the tubular element when said coupling member is subjected to a torque less than a predetermined threshold. The friction portion is advantageously configured to allow the pivoting of the coupling member relative to the tubular element when said coupling member is subjected to a torque greater than this predetermined threshold. The value of this predetermined threshold is preferably less than 1 Newton meter (Nm), preferably approximately equal to 0.2 Nm. In other words, when the torque exerted on the coupling member is less than the value of this predetermined threshold, the coupling member is in sliding linkage relative to the tubular element. When the torque exerted on the coupling member is greater than the value of this threshold, the coupling member is in sliding pivot linkage relative to the tubular element. The value of this predetermined threshold is advantageously selected as low as possible, so that the friction torque is substantially imperceptible during pivoting of the coupling member, but sufficiently high to prevent the pivoting of the coupling member relative to the tubular element during the axial movement of the coupling member.

Preferably, said friction portion comprises a seal, for example a lip seal, fitted to the tubular element. Said friction portion advantageously comprises a flexible internal lip fitted to the tubular element.

Advantageously, said coupling member comprises at least one engagement portion and said axial guide element comprises at least one groove configured to receive said engagement portion, said engagement portion being configured to slide axially inside said groove.

Alternatively, and still advantageously, said coupling member comprises at least one groove and said axial guide element comprises at least one engagement portion configured to engage with said groove, said engagement portion being configured to slide axially inside said groove.

Said at least one engagement portion preferably comprises a spline.

Preferably, the main shaft comprises a rapid mounting device for removably mounting the wheel system relative to said frame of the wheelchair. The mounting device allows the rapid mounting and disassembly of the wheel system relative to the frame.

The rapid mounting device advantageously comprises at least one ball arranged in a cavity formed in the main shaft and a shank configured to extend axially inside the main shaft. Said shank advantageously comprises a thrust portion configured to push on said ball in order to move it radially when said shank is inserted into the main shaft. The ball is then brought into a deployed position in which it protrudes radially from the outer surface of the main shaft. Said ball then forms an abutment blocking the axial movement of the main shaft relative to the wheelchair frame.

The rapid mounting device advantageously allows mounting the wheel system to the frame of the wheelchair without tools.

According to an advantageous variant, the blocking part comprises a rod extending radially relative to the tubular element and a blocking finger extending transversely to said rod, said blocking rod being configured to cooperate with said blocking element of the frame. One benefit is to propose a light blocking part, low in bulk and the manufacture of which is facilitated.

Another benefit is to facilitate the mounting of the wheel system on the frame of the wheelchair in that it is not necessary to pay attention to the relative position of the blocking part and of the blocking element of the frame during said mounting.

In addition, this particular configuration of the blocking part confers better adaptability in that it allows mounting the wheel system on a very large variety of chairs. In fact, most chairs have a framework portion able to form a blocking element for the blocking part.

In this variant, the blocking element is advantageously formed by a portion of the frame of the wheelchair, for example a framework portion supporting the seat of the chair.

The blocking finger is advantageously configured to be supported against said blocking element.

The blocking finger advantageously extends from a distal end of the rod. The blocking finger advantageously extends perpendicular to said rod.

In this embodiment, it is understood that the blocking finger is configured to be supported against the blocking element to block the rotation of the blocking part of the frame to block the rotation of the blocking part, and therefore of the tubular element, relative to the frame of the wheelchair in a single rotation direction, corresponding to the forward rotation direction of the wheel.

In a non-limiting manner, in this variant, the blocking element of the frame does not block the rotation of the blocking part relative to the frame in a rotation direction corresponding to the rotation direction of the wheel in reverse, or at least not immediately.

During braking, the wheel turns in the first rotation direction corresponding to a forward movement of the chair. In this first rotation direction, and therefore during braking, the outer ring of the freewheel clutch is blocked in rotation relative to the inner ring of the freewheel clutch. Consequently, the tubular element tends to pivot in said first rotation direction, driven by the freewheel clutch and the wheel of the chair. The blocking part is then supported on the blocking element of the frame and allows blocking the rotation of the tubular element in said first rotation direction. The freewheel clutch is thus also blocked in rotation in this first rotation direction. Braking can occur as detailed previously, by pivoting the hand-rim.

In a non-limiting manner, during a first use, the blocking part, and particularly the blocking finger, are not necessarily in contact with the blocking element of the frame. During the first braking carried out, the blocking part pivots in the first rotation direction, corresponding to the rotation direction of the wheel during forward movement of the chair, until it is supported against the blocking element of the frame. In a non-limiting manner, the blocking part then remains substantially in contact with the blocking element of the frame and is therefore blocked in rotation in said first rotation direction.

The application also applies to a wheelchair having a frame and comprising at least one wheel system as described previously, said main shaft being mounted on the frame of the wheelchair for the mounting of the wheel system on said frame, the frame comprising at least one blocking element and the blocking part cooperating with said blocking element of the frame. Said wheel system is preferably removably mounted on the frame of the wheelchair.

Preferably, the blocking part cooperates with the blocking element of the frame for blocking the tubular element of the wheel system in rotation relative to the frame.

Preferably, the frame of the wheelchair comprises a connector attached to said frame and with which the blocking element is integral. The connector is suitably selected relative to the frame.

The connector is preferably an insert attached to the frame, for example by means of a screw.

According to a first advantageous variant, the blocking part comprises at least one opening, and the blocking element comprises a blocking pin extending radially at a distance from the main shaft and cooperating with said opening of the blocking part for blocking the tubular element in rotation relative to the frame.

In a non-limiting manner, the blocking pin can be inclined relative to the main axis when the wheel system is mounted on the frame, particularly when the wheel is inclined relative to the vertical by a camber angle.

According to another advantageous variant, and without departing from the scope of the application, the frame advantageously comprises at least one opening, and the blocking part advantageously comprises a blocking pin extending radially at a distance from the main shaft and cooperating with said opening of the frame for blocking the tubular element in rotation relative to the frame.

Preferably, the blocking pin comprises a spherical portion engaging with said at least one opening of the blocking part. In other words, the blocking pin has a ball-joint link with the blocking part.

One benefit is to facilitate the initiation of cooperation of the blocking element with the blocking part, even if the wheel were inclined relative to the vertical by a camber angle, and therefore even if the blocking element were inclined relative to the main axis.

Another benefit is to allow mounting without clearance of the wheel system on the frame, despite the possible camber angle by which the wheel extends.

According to another advantageous variant, the blocking part comprises a rod extending radially relative to the tubular element and a blocking finger extending transversely to said rod, and the blocking element comprises a framework portion of the chair frame, the blocking finger being configured to be supported against said framework portion.

### BRIEF DESCRIPTION OF THE DRAWINGS

The application will be better understood upon reading the description that follows of embodiments of the application given by way of non-limiting examples, with reference to the appended drawings, in which:

FIG. 1 shows a wheelchair;

FIG. 2 is a section view of a first embodiment of a wheel system of the wheelchair of FIG. 1;

FIG. 3 illustrates a brake shoe of the wheel system of FIG. 2;

FIG. 4 illustrates the wheel system of FIG. 2, the hub having been withdrawn;

FIG. 5 shows the axial guide element of the wheel system of FIG. 2;

FIG. 6 shows the cooperation between the axial guide element and the coupling member of the wheel system of FIG. 2;

FIG. 7 is a section view of a second embodiment of a wheel system;

FIG. 8 shows the blocking part of the wheel

system of FIG. 2;

FIG. 9 is a section view illustrating the mounting of the wheel system of FIG. 7 on the frame of the wheelchair;

FIG. 10 shows the rapid mounting device of the wheel system of FIG. 7;

FIG. 11 shows the cooperation between the blocking element and the blocking part of the wheel system of FIG. 7;

FIG. 12 is a perspective view of a third embodiment of a wheel system;

FIG. 13 is a section view of the wheel system of FIG. 12;

FIG. 14 is a side view of the wheel system of FIG. 12, prior to accomplishing a first braking; and

FIG. 15 is a side view of the wheel system of FIG. 12, during the first braking.

### DESCRIPTION OF THE EMBODIMENTS

The application applies to a wheelchair wheel system as well as to a wheelchair comprising a wheel system of this type.

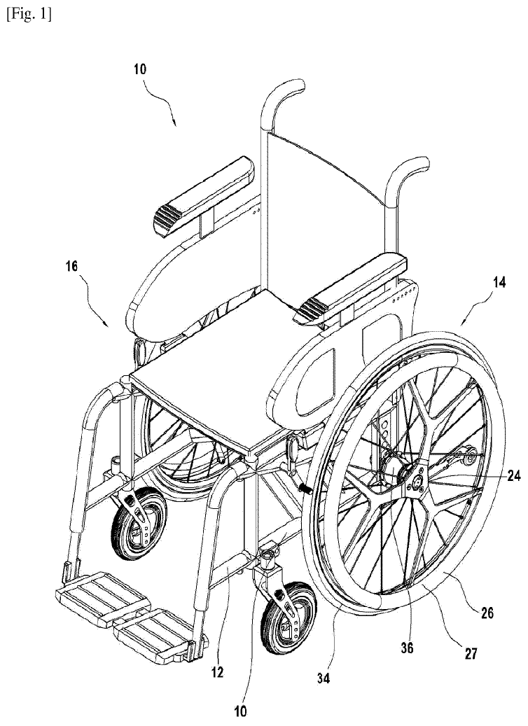

FIG. 1 is a perspective view of a wheelchair 10 according to the application, comprising a frame 12 on which are mounted a first wheel system 14 according to the application and a second wheel system 16 according to the application. The first and second wheel systems 14, 16 being substantially symmetrical, only the first wheel system 14 will be described in detail hereafter. The first wheel system 14 comprises a wheel 34, visible in FIG. 1, comprising a hub 36 connected to a rim by means of spokes. A tire is mounted on the rim.

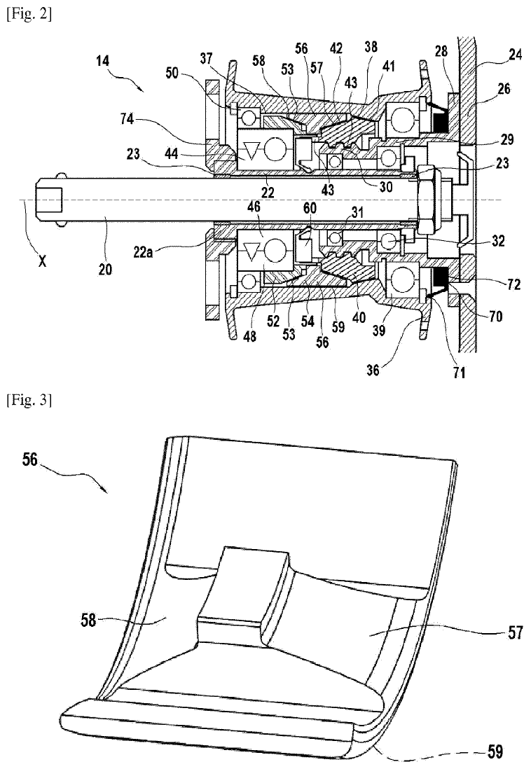

FIG. 2 is a section view of a first embodiment of the first wheel system 14 of FIG. 1. As illustrated in this FIG. 2, the first wheel system 14 comprises a main shaft 20 extending along a main axis X. The first wheel system 14 also comprises a tubular element 22 receiving the main shaft 20 and extending along said main axis X. The tubular element 22 has the shape of a sleeve. It is hollow and surrounds the main shaft 20. The main shaft 20 is engaged inside the tubular element 22 and is blocked in axial translation relative to said tubular element by means of a nut attached to the end of the main shaft, in an axial movement direction.

The wheel system also comprises two rings 23 fitted to the main shaft and coming into abutment on the shoulders formed inside the tubular element 22. The tubular element extends essentially inside the hub 36.

Additionally, the first wheel system 14 comprises a hand-rim 24 comprising a circular actuating portion 26 particularly visible in FIG. 1, and an extension portion 28 visible in FIG. 2. The extension portion 28 is integral with the circular actuating portion 26, by means of a screw in this non-limiting example.

As can be seen in FIG. 1, the circular actuating portion 26 of the hand-rim 24 extends radially relative to the main shaft 20 and to the tubular element 22. The circular actuating portion 26 comprises a toroidal shaped knob 27 extending in the periphery of said circular actuating portion 26.

The extension portion 28 of the hand-rim 24 extends axially along the main axis X. The extension portion 28 extends around the tubular element 22 and therefore around the main shaft 20. It is mounted pivotally around the main axis X relative to the tubular element 22. The extension portion has a generally cylindrical shape. The extension portion 28 comprises a threaded portion 30 formed at a distal end of the extension portion. The extension portion 28 also comprises a cylindrical portion 29 located between said threaded portion 30 and the circular actuating portion 26.

The extension portion 28 of the hand-rim 24 is mounted pivotally relative to the tubular element 22 by means of a first bearing 31 and of a second bearing 32 located inside the hub 36. In this non-limiting example, the first and second bearings 31, 32 are ball bearings. Without departing from the scope of the application, these bearings could be needle bearings. The first bearing 31 is arranged between the tubular element 22 and the threaded portion 30 of the extension portion 28. The second bearing 32 is arranged between the tubular element 22 and the cylindrical portion 29 of the extension portion 28 of the hand-rim 24.

For reasons of clarity, only the hub 36 and the wheel 34 are shown in FIG. 2. The hub 36 has an inner face 37 having an inner conical surface 38. Considered in the section plane, this inner conical surface 38 is inclined relative to the main axis X. The hub 36 is mounted pivotally relative to the extension portion 28 of the hand-rim by means of a first external bearing 39 arranged between the hub 36 and said extension portion 28. Here this first external bearing 39 is a ball bearing.

The first wheel system 14 also comprises a coupling member 40 located inside the hub 36. The coupling member has a generally cylindrical shape. The coupling member 40 has a threaded, and more precisely tapped, portion 43, engaged with the threaded portion 30 of the extension portion 28 of the hand-rim 24. The coupling member 40 is in helical linkage with the extension portion 28 of the hand-rim. Thus, pivoting of the hand-rim 24 in a first rotation direction causes the axial translation movement of the coupling member 40 along the main axis X in a first movement direction, while pivoting of the hand-rim 24 in a second rotation direction, opposite to the first rotation direction, causes the axial translation movement of the coupling member 40 in a second movement direction, opposite to the first movement direction.

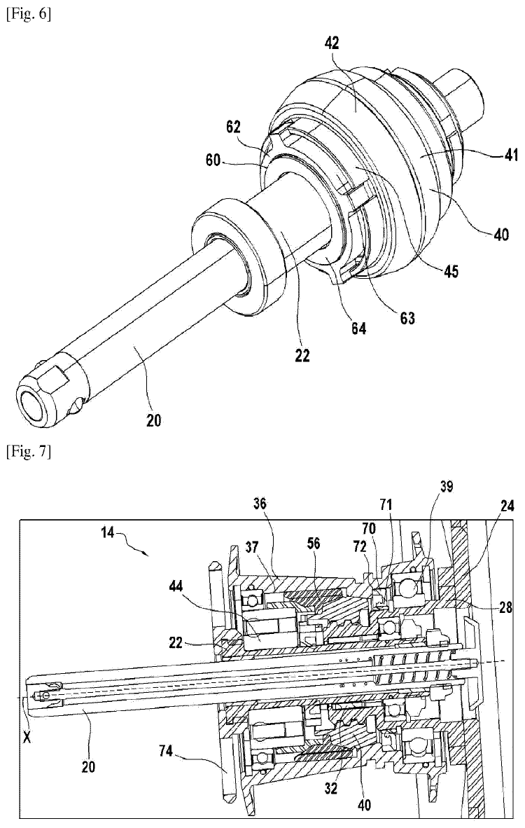

The coupling member 40 also comprises a conical coupling surface 41 inclined relative to the main axis X considered in the section plane. This coupling surface 41 is positioned facing the inner conical surface 38 of the inner face 37 of the hub 36. The coupling member 40 also comprises a ramp 42 also inclined relative to the main axis. The coupling member 40 comprises a plurality of engagement portions 45, here four engagement portions 45, extending axially. These engagement portions 45 are illustrated in FIG. 6. These engagement portions have the shape of splines extending along the main axis X.

Hereafter, the first rotation direction will be defined as a rotation of the wheel or of the hand-rim in a direction corresponding to a forward movement of the wheelchair 10. The second rotation direction will be defined as a rotation of the wheel or of the hand-rim in a direction corresponding to braking or to reverse movement of the wheelchair 10.

The first wheel system 14 comprises moreover an freewheel clutch 44 located inside the hub 36, i.e. in the interior volume of the hub. Here the freewheel clutch 44 is a cam-type freewheel clutch. The freewheel clutch 44 comprises an inner ring 46 and an outer ring 48. The inner ring 46 is attached to the tubular element 22. The outer ring 48 is blocked in rotation relative to the inner ring 46 in the first rotation direction and free in rotation relative to the inner ring 46 in the second rotation direction.

The hub 36 is mounted pivotally relative to the outer ring 48 of the freewheel clutch 44 by means of a second external bearing 50. In this non-limiting example, the second external bearing 50 is a ball bearing.

The first wheel system 14 also comprises a plug 52 extending along the main axis X, around the tubular element 22 and attached to the outer ring 48 of the freewheel clutch 44. The plug 52 has a housing receiving the outer ring 48 of the freewheel clutch 44. The plug 52 is located in the hub 36. The plug also has a conical plug surface 53 inclined relative to the main axis X.

The wheel system 14 also comprise a braking device 54 comprising two brake shoes 56 located in the hub 36. A brake shoe 56 is illustrated in FIG. 3. In this non-limiting example, the brake shoes 56 have the shape of a portion of a cylinder describing a circular arc, the perimeter of which is less than a quarter-circle. Each of the brake shoes 56 comprises a first conical surface 57, a second conical surface 58. Considered in a longitudinal section plane, the first and second conical surface 57, 58 of the brake shoes are inclined relative to the main axis X and inclined relative to one another. The brake shoes 56 also comprise a braking surface 59 forming an outer surface of the brake shoes 56.

As illustrated in the perspective view of FIG. 4, in which the wheel 34 and its hub have been withdrawn for greater clarity, the brake shoes 56 are arranged between the hub 36, the plug 52 and the coupling member 40. The two brake shoes 56 are arranged on either side of the tubular element 22 and diametrically opposed. The first conical surfaces 57 of the brake shoes 56 are arranged facing the ramp 42 of the coupling member 40. The second conical surfaces 58 of the brake shoes 56 are arranged facing the conical plug surface 53 of the plug 52.

Moreover, the brake shoes 56 are blocked in rotation relative to the plug 52 and therefore relative to the outer ring 48 of the freewheel clutch, regardless here of the position of the coupling member 40. The brake shoes 56 and the outer ring of the freewheel clutch are therefore coupled in rotation, by means of the plug 52. The brake shoes 56 are thus blocked in rotation relative to the inner ring 46, and therefore relative to the tubular element 22, in the first rotation direction and free in rotation relative to the inner ring 46, and therefore relative to the tubular element 22, in the second rotation direction.

Referring again to FIG. 2, it is noted that the first wheel system 14 comprises moreover an axial guide element 60. The axial guide element 60 is located in the hub 36. It has a substantially cylindrical shape and is mounted pivotally around the tubular element 22. In this non-limiting example, the axial guide element 60 is located between the extension portion 28 of the hand-rim 24 and the freewheel clutch 44. The axial guide element 60 also extends inside the plug 52.

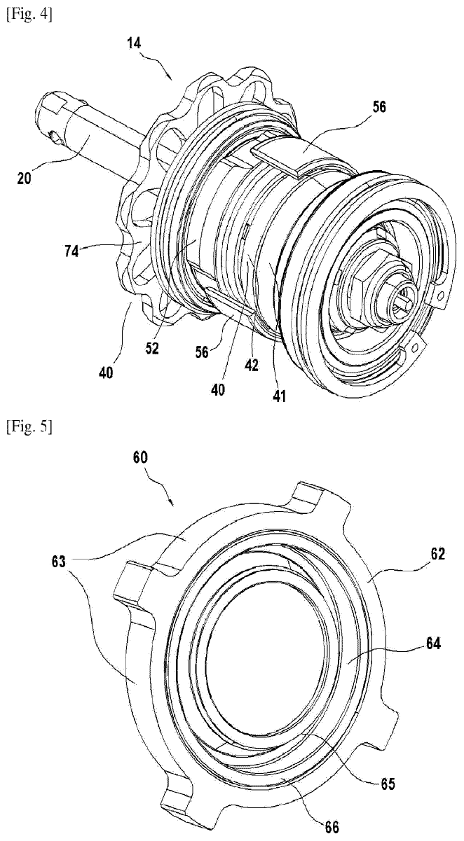

As illustrated in the perspective view of FIG. 5, the axial guide element 60 comprises an axial guide portion 62, which is circular, and a friction portion 64 arranged inside the axial guide portion 62. The friction portion 64 is deformable. It comprises a lip seal, also called an SPI seal, comprising a flexible internal lip 65 connected to a rigid peripheral ring 66. The flexible internal lip 65 of the friction portion 64 is fitted to the tubular element 22. The axial guide element 60, by means of the friction portion 64, is configured to exert a slight friction torque on said tubular element 22. This torque tends to oppose the pivoting of said axial guide element 60 relative to the tubular element 22.

The coupling member 40 is movable in translation relative to the axial guide element 60 while being blocked in rotation relative to this axial guide element. To this end, as illustrated in FIG. 6, the axial guide portion 62 of the axial guide element 60 comprises a plurality of grooves 63, here four grooves 63, configured to receive the engagement portions 45 of the coupling member 40.

The axial guide element 60 is configured to prevent the pivoting of the coupling member 40 relative to the tubular element 22 when said coupling member 40 is subjected to a torque less than a predetermined threshold. The axial guide element 60 is configured to allow the pivoting of the coupling member 40 relative to the tubular element 22 when said coupling member 40 is subjected to a torque greater than said predetermined threshold. The value of this predetermined threshold is approximately 0.2 Newton meters (Nm).

The engagement of the engagement portions 45 of the coupling member 40 in the grooves 63 of the axial guide element 60 is illustrated in FIG. 6.

The first wheel system 14 also comprises a friction part 70 arranged between the extension portion 28 of the hand-rim 24 and the hub 36. In the non-limiting example of FIG. 2, the friction part 70 comprises a lip seal having a flexible lip 71 in contact with the hub 36 and a rigid ring 72 attached to said extension position 28 of the hand-rim. In this non-limiting example, the friction part 70 is positioned between an axial end of the hub 36 and the main portion 26 of the hand-rim 24.

The friction part is configured to generate a friction torque between the hub and the extension portion 28 of the hand-rim, and therefore between the hand-rim 24 and the wheel 34. The friction part 70 allows driving the hand-rim 24 in rotation during pivoting of the hub and therefore of the wheel 34, due to which the hand-rim follows the rotation movement of the wheel. This allows avoiding that the hand-rim remains immobile when the wheel is driven in rotation, particularly in the first rotation direction, reducing the amplitude of the thrust that it is necessary to exert on the hand-rim to drive the wheel 34 in rotation.

FIG. 7 illustrates a variant of the wheel system 14 according to the application, in which the friction part 70 is located between the first external rolling-element bearing 39 and the coupling member 40. Here the flexible lip 71 of the friction part 70 is in contact with the extension portion 28 while the rigid ring 72 is attached to the inner face 37 of the hub 36.

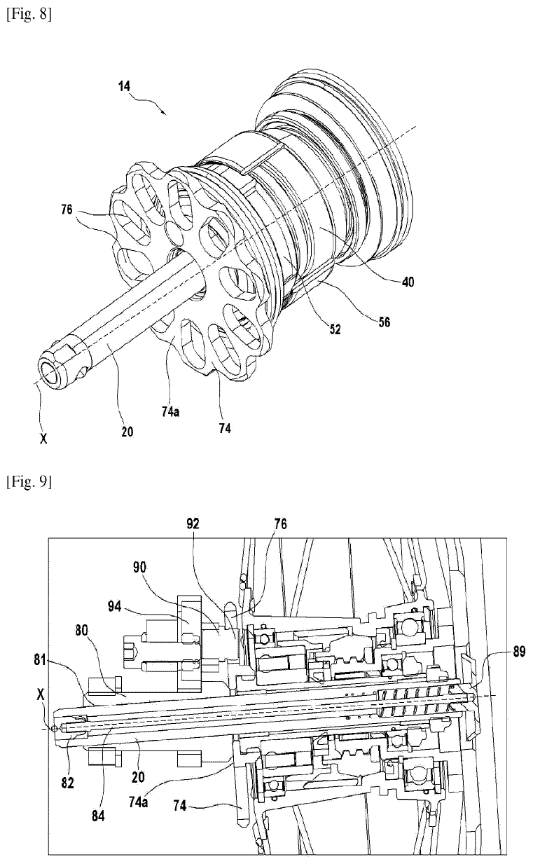

Referring again to the embodiment of FIG. 2, it is noted that the first wheel system 14 also comprises a blocking part 74 integral with the tubular element 22. In this non-limiting example, the blocking part 74 and the tubular element 22 are two distinct parts attached to one another. The blocking part 74 is attached to an end 22a of the tubular element 22, opposite to the hand-rim 24. The blocking part is therefore located opposite to the hand-rim. The blocking part 74 is configured to cooperate with a blocking element of the frame for blocking the tubular element 22 in rotation relative to the frame. This blocking part 74 is illustrated in the perspective view of FIG. 8.

This blocking part 74 has substantially the shape of a disk, or even the shape of a daisy. The blocking part 74 extends radially relative to the tubular element 22 and to the main axis X. It is also crossed by the main shaft 20. The blocking part 74 and the circular actuating portion 26 of the hand-rim 24 are arranged on either side of the hub 36, considered axially. Several openings 76 are provided in the rotation blocking part 74 and arranged on the perimeter of a circle centered on the main axis X, or even on the center of the disk. These openings 76 have an oblong shape.

The blocking part 74 also comprises a lateral face 74a opposite to the hand-rim.

To mount the first wheel system 14 to the frame 12 of the wheelchair 10, the main shaft 20 is inserted into a spindle barrel 80 integral with the frame 12 and having the shape of a sleeve, as illustrated in FIG. 9. In this non-limiting example, the spindle barrel 80 has a through opening 81 extending along a barrel axis that is inclined relative to the horizontal. Thus, when the main shaft 20 is inserted into the spindle barrel 80, the main axis X of the main shaft is coincident with the barrel axis and is also inclined relative to the horizontal. Thus, the wheel 34 is inclined relative to the vertical by a camber angle, facilitating in particular the passage of doorways. The diameter of the through opening 81 is very slightly greater than the diameter of the main shaft 20.

In this non-limiting example, the main shaft 20 comprises a rapid mounting device 82 for removable mounting of the first wheel system 14 relative to said frame 12 of the wheelchair. This rapid mounting device 82 comprises an axial shank 84 mounted slidably inside the main shaft 20. The axial shank extends along the main axis X.

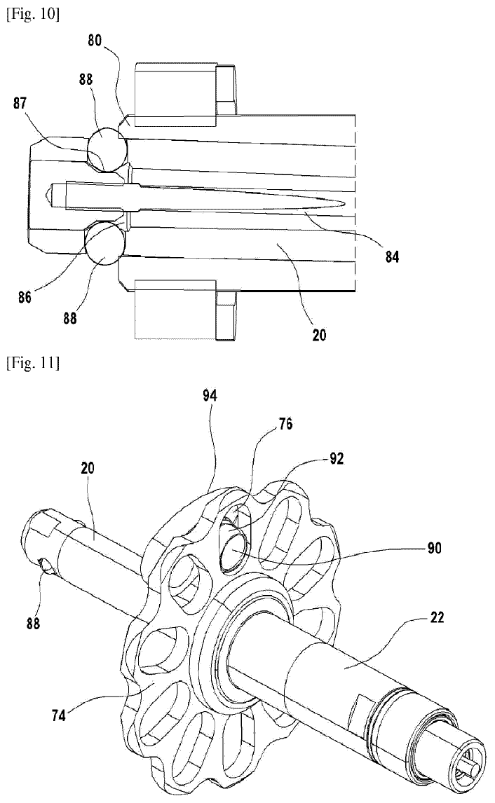

As illustrated in FIG. 10, the axial shank 84 has a first end provided with a thrust portion 86, the diameter of which is greater than the diameter of the axial shank. The rapid mounting device 82 also comprises two balls 88 housed in cavities 87 provided at the end of the main shaft 20 and movable radially in translation inside these cavities. The axial shank 84 also has a second end, opposite to the first end, and provided with a gripping portion 89 allowing manipulating the axial shank.

To mount the wheel system on the frame, the main shaft 20 is inserted into the through opening 81 of the spindle barrel 80 until the lateral face 74a of the blocking part 74 comes into abutment on the spindle barrel 80. The tubular element 22 is thus blocked in axial translation relative to the main shaft 20, in the direction of the frame 12.

The cavities 87 are then positioned outside the spindle barrel 80, as illustrated in FIG. 10. The gripping portion 89 and the cavities 87 then extend on either side of the spindle barrel. The balls 88 then extend into the cavities inside the main shaft, without protruding radially from the outer surface of the main shaft.

In order to block the main shaft 20 in translation relative to the spindle barrel 80, the shank 84 is inserted into the main shaft until the thrust portion 86 presses on the balls 88 so as to move them radially within the cavities. The balls 88 then protrude radially from the outer surface of the main shaft 20 and come into abutment on the spindle barrel, preventing the withdrawal of the main shaft out of the spindle barrel 80. Henceforth, the tubular element 22 and therefore the main shaft 20 are blocked in translation relative to the spindle barrel 80 and therefore to the frame 12.

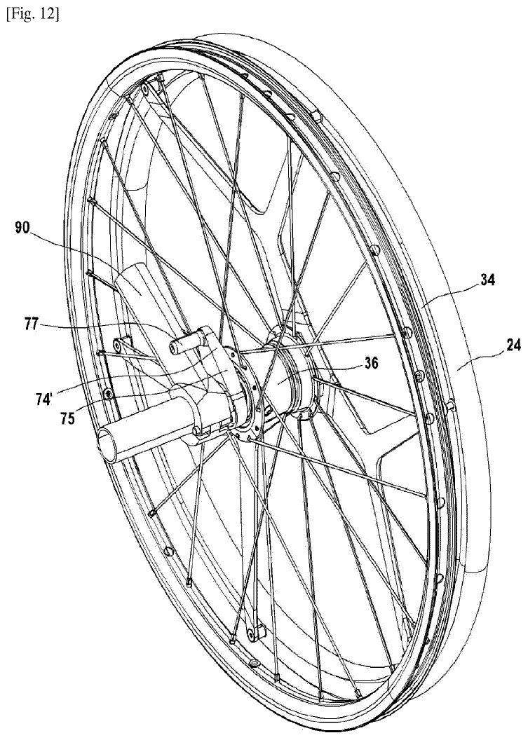

In order to block the tubular element 22 in rotation relative to the frame 12 of the wheelchair 10, the frame is provided with a blocking element 90 consisting, in this non-limiting example, of a blocking pin 90 illustrated in FIGS. 9 and 11. This blocking element 90 comprises a spherical portion 92. In this non-limiting example, as illustrated in FIG. 11, the blocking element 90 is attached to an inset connector 94, itself attached to the frame 12. The blocking element 90 is radially distant from the main shaft 20 and from the tubular element 22. The blocking element 90 extends substantially horizontally.

The blocking element cooperates with one of the oblong openings 76 of the blocking part 74, thus blocking the rotation of the blocking part and therefore of the tubular element 22 around the main axis X. Taking into account the oblong shape of the openings 76 of the blocking part 74 and of the spherical portion 92 of the blocking element 90, the blocking element can easily be placed in cooperation with one of the openings, while limiting the clearance between the blocking element and the blocking part and therefore between the tubular element and the frame.

We will now detail the driving in forward motion, the braking and the driving in reverse of a wheel 34 of the wheel system 14 of the wheelchair 10 according to the application, with reference to FIG. 2.

To move the wheel 34 in the first rotation direction, corresponding to a rotation direction for forward movement of the wheelchair 10, the user drives the hand-rim 24 in this same first rotation direction, around the main axis X. The extension portion 28 of the hand-rim 24 pivots in this first rotation direction around the main axis X. The coupling member 40, the threaded portion 43 of which is engaged with the threaded portion 30 of the extension portion 28, is moved in axial translation along the main axis in a first movement direction. The coupling member 40 is moved toward the inner conical surface 38 of the inner face 37 of the hub 36 until said coupling member is brought into a first position.

In this first position, the coupling surface 41 of the coupling member 40 is supported against the inner conical surface 38 of the inner face 37 of the hub 36, so that the axial movement of the coupling member is interrupted. Henceforth, the hub 36 and the hand-rim 24 are linked in rotation by means of the coupling member 40. The pivoting of the hand-rim in the first direction of rotation then causes the movement of the wheel in this same first rotation direction. In this first rotation direction of the wheel, the outer ring 48 of the freewheel clutch 44 is blocked in rotation relative to the inner ring 46. The hub 36 being mounted pivotally relative to the outer ring 48 of the freewheel clutch, it can however pivot in this first rotation direction so that the wheel can pivot around the main axis X relative to the tubular element 22.

In other words, the pivoting of the hand-rim 24 in the first rotation direction causes the movement of the wheel 34 in this same first rotation direction, corresponding to a forward movement of the chair 10.

The axial guide element 60 allows preventing the rotation of the coupling member 40 during its axial movement, for example toward the first position or even toward the second position, without however preventing the pivoting of the coupling member when it is coupled to the hub 36 or to the brake shoe 56.

From this first position, when the user no longer pivots the hand-rim 24, the coupling member 40 moves axially slightly in a second movement direction, opposite to the first movement direction. The coupling member 40 moves away from the inner conical surface 38 of the hub and moves closer to the brake shoe 56. Taking into account this slight movement, the coupling surface 41 of the coupling member 40 no longer comes into contact against the inner conical surface 38 of the inner face 37 of the hub, and coupling between the hand-rim 24 and the wheel 34 is interrupted. However, the wheel 34 continues pivoting freely in the first rotation direction, and the chair continues to advance.

In order to accomplish the braking of the wheel 34, the user pivots the hand-rim 24 in the second rotation direction, opposite to the first rotation direction. This second rotation direction corresponding to a braking or even reverse movement direction for the chair.

The coupling member 40, the threaded portion 43 of which is engaged with the threaded portion 30 of the extension portion 28 of the hand-rim, is driven in translation by the extension portion of the hand-rim 24. It moves axially in the second movement direction, toward the brake shoes 56. In this second movement direction, the coupling member 40 is moved toward the plug 52 and the freewheel clutch 44.

The coupling member 40 is moved until it reaches the second position, in which its ramp 42 comes into contact with the first conical surface 57 of the brake shoes 56. The second conical surface 58 of the brake shoes is pressed against the conical plug surface 53 of the plug 52. The brake shoes 56 are then sandwiched between the coupling member and the plug. The coupling member 40 than exerts a force on the brake shoes 56, which separate and are moved radially toward the hub 36. The braking surface 59 of the brake shoes then comes into contact with the hub, thus accomplishing the braking of the wheel 34.

In other words, the pivoting of the hand-rim 24 in the second rotation direction drives the braking of the wheel.

During braking, and until it is completely stopped, the wheel 34 continues to turn in the first rotation direction and the outer ring 48 of the freewheel clutch is blocked in rotation relative to the inner ring 46 of the freewheel clutch. The wheel can turn, however, taking into account the pivot linkage between the hub and the outer ring of the freewheel clutch.

When the wheel 34 pivots in the first rotation direction and therefore during braking, the plug 52 and the brake shoes 56 are blocked in rotation relative to the tubular element 22, taking into account the blockage in rotation of the outer ring of the freewheel clutch.

To pivot the wheel in the second rotation direction, corresponding to a reverse movement of the chair, the user pivots the hand-rim 24 in this second rotation direction. Consequently, the coupling member pushes the brake shoes 56 against the hub, there again generating a coupling between the hand-rim and the hub 36. The hub 36 and therefore the wheel 34 are driven in rotation in the second rotation direction. In this second rotation direction, the outer ring 48 of the freewheel clutch 44 is free in rotation relative to the inner ring 46. The pivoting of the hub in the second rotation direction is allowed by the coupling in rotation of the brake shoes 56 with the outer ring of the freewheel clutch, which itself is free in rotation relative to the inner ring of the freewheel clutch in this second rotation direction.

In this second position of the coupling member 40, the plug 52 is also coupled to the brake shoes 56 and to the hub 36. The plug and the brake shoes also pivot in this second rotation direction.

In other words, a movement of the hand-rim 24 in this second rotation direction causes the movement in rotation of the wheel 34 in this second rotation direction, corresponding to a reverse movement of the wheelchair 10.

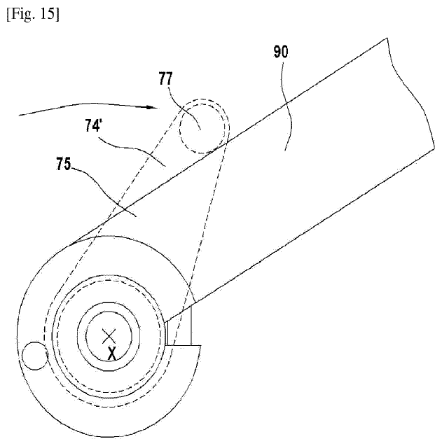

FIGS. 12 to 15 illustrate a third embodiment of the wheel system 14 according to the application, distinguished from that of the preceding figures in that it comprises a variant of the blocking part.

In the perspective view of FIG. 12, it is observed that in this embodiment, the blocking part 74′ comprises a rod 75 integral with the tubular element 22 and extending radially relative to said tubular element and to the main axis X. The blocking part 74′ also comprises a blocking finger 77 attached to the rod 75 and extending transversely, preferably perpendicularly, to said rod.

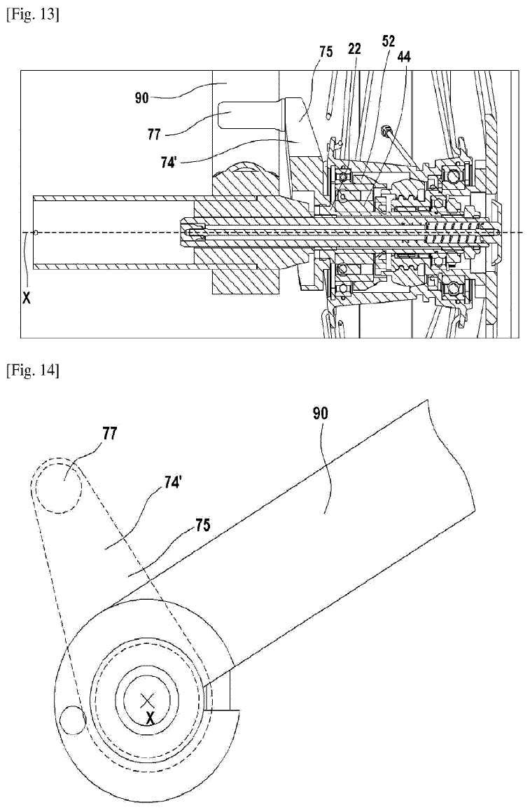

As can be seen in the section view of FIG. 13, the blocking finger 77 extends substantially parallel to the main axis X. The blocking finger 77 extends from a distal end of said rod 75.

In this embodiment, the blocking element 90 of the frame 12 of the wheelchair is formed by a substantially tubular framework portion of the frame 12 of the wheelchair. This blocking element 90 extends transversely to the main axis X and to the tubular element 22, when the wheel 34 is mounted on the frame.

FIG. 14 shows the wheel system of FIGS. 12 and 13 in side view, during a first use, after the mounting of the wheel 34 on the frame 12 of the wheelchair 10. During this first use following mounting, the blocking part 74′ and particularly the blocking finger 77 are not necessarily in contact with the blocking element 90 of the frame. Consequently, the blocking part 74′ and the tubular element 22 are not immediately blocked in rotation. The blocking part can therefore pivot around the main axis X in both rotation directions.

During the first braking, and as illustrated in FIG. 14, the blocking part 74′ and the tubular element 22 are driven in rotation, taking into account the pivoting of the wheel around the main axis. More precisely, during braking, the wheel 34, which pivots in a first rotation direction corresponding to a forward movement of the chair, drives the freewheel clutch 44, which is blocked, and therefore the tubular element 22 in this same first rotation direction. The blocking finger 77 of the blocking part 74′ then comes into contact with the blocking element 90 of the frame, so that the blocking part and the tubular element 22 are then blocked in rotation in this first rotation direction. Henceforth, this blocking in rotation allows the braking and the driving of the wheel in a direction corresponding to reverse movement. The operations of braking and of driving in forward movement and in reverse movement of the wheelchair 10 are then as described in relation to the preceding embodiments. In particular, the freewheel clutch is entirely blocked in rotation in the first rotation direction around the main axis X, while the outer ring of the freewheel clutch can pivot relative to the inner ring of the freewheel clutch in the second rotation direction.

The blocking part 74′ is not blocked in rotation in a second rotation direction, opposite to the first rotation direction, but tends however not to pivot in said second rotation direction. The blocking part 74′ therefore tends to remain supported against the blocking element 90 of the frame.

1. A wheelchair wheel system having a frame, the wheelchair wheel system comprising:
a wheel having a hub having a main axis, the hub comprising an inner face provided with an inner conical surface;
a main shaft configured to be mounted on the frame of the wheelchair;
a tubular element extending along the main axis, the main axis being engaged in said tubular element;
a hand-rim mounted pivotally around the main axis relative to the tubular element and coupled to the wheel for driving in rotation and braking of the wheel, the hand-rim comprising a circular actuation portion and an extension portion extending in the hub, said extension portion surrounding the tubular element and having a threaded portion;
at least one brake shoe located in the hub and comprising a braking surface and at least one first conical surface;
a coupling member comprising a coupling surface, a ramp and a threaded portion engaged with the threaded portion of the extension portion of the hand-rim to move the coupling member axially relative to the hub, the coupling member being movable in axial translation between at least one first position in which its coupling surface is supported against the inner conical surface of the hub, so as to link the hand-rim and the hub in rotation, and a second position in which the ramp of the coupling member presses against the at least one first conical surface of the at least one brake shoe to radially push the at least one brake shoe against the inner surface of the hub;
an freewheel clutch comprising an inner ring fixed relative to the tubular element and an outer ring blocked in rotation relative to the inner ring in a first rotation direction and free in rotation relative to the inner ring in a second rotation direction opposite to the first rotation direction, the hub of the wheel being mounted pivotally relative to the outer ring of the freewheel clutch, the at least one brake shoe being linked in rotation with the outer ring of the freewheel clutch when the coupling member is in the second position; and
a blocking part integral with the tubular element and located opposite the hand-rim, the blocking part being configured to cooperate with a blocking element of the frame.

2. The wheelchair wheel system according to claim 1, comprising at least one first bearing located inside the hub and arranged between said threaded portion of the extension portion of the hand-rim and said tubular element.

3. The wheelchair wheel system according to claim 2, wherein the extension portion of the hand-rim comprises a cylindrical portion located between the threaded portion and the circular actuation portion, the wheelchair wheel system further comprising a second bearing arranged between said cylindrical portion of the extension portion and said tubular element

4. The wheelchair wheel system according to claim 1, further comprising an external bearing arranged between the outer ring of the freewheel clutch and the hub.

5. The wheelchair wheel system according to claim 1, wherein the blocking part has the general shape of a disk, a plurality of openings being provided in the disk and arranged on the periphery of a circle centered on the center of the disk.

6. The wheelchair wheel system according to claim 1, wherein said blocking part has a lateral face configured to come into abutment on a portion of the frame when the main shaft is mounted on said frame.

7. The wheelchair wheel system according to claim 1, further comprising a friction part arranged between the hand-rim and the wheel and configured to generate a friction torque between said hand-rim and the wheel during the pivoting of said wheel

8. The wheelchair wheel system according to claim 7, wherein the friction part is arranged between the extension portion of the hand-rim and the hub.

9. The wheelchair wheel system according to claim 1, further comprising an axial guide element mounted pivotally around the tubular element, the coupling member being movable in translation along the main axis relative to said axial guide element while being blocked in rotation around the main axis relative to this axial guide element, the axial guide element comprising a friction portion cooperating with the tubular element and configured to exert a friction torque on said tubular element.

10. The wheelchair wheel system according to claim 9, wherein said friction portion is deformable and is configured to prevent the pivoting of the coupling member relative to the tubular element when said coupling member is subjected to a torque less than a predetermined threshold.

11. The wheelchair wheel system according to claim 9, wherein said coupling member comprises at least one engagement portion and wherein said axial guide element comprises at least one groove configured to receive said engagement portion, said engagement portion being configured to slide axially inside said at least one groove.

12. The wheelchair wheel system according to claim 1, wherein the main shaft comprises a rapid mounting device for removably mounting the wheelchair wheel system relative to said frame of the wheelchair.

13. A wheelchair having a frame and comprising at least one wheel system, wherein a main shaft mounted to the a frame of the wheelchair for the mounting of the at least one wheel system to said frame, wherein the frame comprises at least one blocking member and wherein a blocking part cooperates with said blocking element of the frame.

14. The wheelchair according to claim 13, wherein the blocking part comprises at least one opening, and wherein the blocking element comprises a blocking pin extending radially at a distance from the main shaft and cooperating with said at least one opening of the blocking part for blocking the a tubular element in rotation relative to the frame

15. The wheelchair according to claim 14, wherein the blocking pin comprises a spherical portion engaging with said at least one opening in the blocking part.

16. A wheelchair comprising:
a wheel system having a frame, the wheel system comprising:
a wheel having a hub having a main axis, the hub comprising an inner face provided with an inner conical surface;
a main shaft configured to be mounted on the frame of the wheelchair;
a tubular element extending along the main axis, the main axis being engaged in said tubular element;
a hand-rim mounted pivotally around the main axis relative to the tubular element and coupled to the wheel for driving in rotation and braking of the wheel, the hand-rim comprising a circular actuation portion and an extension portion extending in the hub, said extension portion surrounding the tubular element and having a threaded portion;
at least one brake shoe located in the hub and comprising a braking surface and at least one first conical surface;
a coupling member comprising a coupling surface, a ramp and a threaded portion engaged with the threaded portion of the extension portion of the hand-rim to move the coupling member axially relative to the hub, the coupling member being movable in axial translation between at least one first position in which its coupling surface is supported against the inner conical surface of the hub, so as to link the hand-rim and the hub in rotation, and a second position in which the ramp of the coupling member presses against the at least one first conical surface of the at least one brake shoe to radially push the at least one brake shoe against the inner surface of the hub;
an freewheel clutch comprising an inner ring fixed relative to the tubular element and an outer ring blocked in rotation relative to the inner ring in a first rotation direction and free in rotation relative to the inner ring in a second rotation direction opposite to the first rotation direction, the hub of the wheel being mounted pivotally relative to the outer ring of the freewheel clutch, the at least one brake shoe being linked in rotation with the outer ring of the freewheel clutch when the coupling member is in the second position; and
a blocking part integral with the tubular element and located opposite the hand-rim, the blocking part being configured to cooperate with a blocking element of the frame.

17. The wheelchair according to claim 16, further comprising at least one first bearing located inside the hub and arranged between said threaded portion of the extension portion of the hand-rim and said tubular element.

18. The wheelchair according to claim 17, wherein the extension portion of the hand-rim comprises a cylindrical portion located between the threaded portion and the circular actuation portion, the wheel system further comprising a second bearing arranged between said cylindrical portion of the extension portion and said tubular element.

19. The wheelchair according to claim 18, further comprising an external bearing arranged between the outer ring of the freewheel clutch and the hub.

20. The wheelchair according to claim 18, wherein the blocking part has the general shape of a disk, a plurality of openings being provided in the disk and arranged on the periphery of a circle centered on the center of the disk.
